(19) United States
(12) Patent Application Publication
(10) Pub. No.: US 2006/0001801 A1
(43) Pub. Date: Jan. 5, 2006

(54) Method for fabricating a color filter substrate

(75) Inventors: Jung Han Kim, Andong-si (KR); Ji Hyun Kim, Suwon-si (KR)

Correspondence Address: MORGAN LEWIS & BOCKIUS LLP, 1111 PENNSYLVANIA AVENUE NW, WASHINGTON, DC, 20004, US

(73) Assignee: LG.Philips LCD Co., Ltd.

(21) Appl. No.: 11/158,030

(22) Filed: Jun. 22, 2005

(30) Foreign Application Priority Data
Jun. 30, 2004 (KR) P2004-050216

(51) Int. Cl. G02F 1/1335

(52) U.S. Cl. 349/106

(57) ABSTRACT

A method for fabricating a color filter substrate for use in a display device is disclosed. The disclose method includes forming a black matrix on a substrate, forming a color filter layer over the black matrix and the substrate, and forming an overcoat layer over the color filter layer. The method also includes inspecting the black matrix and the color filter layer for pinholes, and if a pinhole is detected in the black matrix or the color filter layer, repairing the detected pinhole by injecting a corresponding ink into the pinhole.

This application claims the benefit of the Korean Patent Application No. P2004-50216 filed on Jun. 30, 2004, which is hereby incorporated by reference.

### BACKGROUND OF THE INVENTION

1. Field of the Invention

The present invention relates to a fabricating method of a liquid crystal display panel, and more particularly, to a method for fabricating a color filter substrate of a liquid crystal display panel.

2. Description of the Related Art

A liquid crystal display device controls the light transmissivity of liquid crystal, which has dielectric anisotropy, by use of electric field, thereby displaying a picture. For this, the liquid crystal display device includes a liquid crystal display panel, which displays a picture through a liquid crystal cell matrix, and a drive circuit to drive the liquid crystal display panel.

As shown in FIG. 1, the related art liquid crystal display panel includes a color filter substrate 10 and a thin film transistor substrate 20 which are bonded together with liquid crystal 24 therebetween.

The color filter substrate 10 includes a black matrix 4, a color filter 6 and a common electrode 8 which are sequentially formed on an upper glass substrate 2. The black matrix 4 is formed on the upper glass substrate 2 in a matrix shape. The black matrix 4 divides an area of the upper glass substrate 2 into a plurality of cell areas where the color filter 6 is to be formed, and it prevents the light interference between adjacent cells and the reflection of an external light. The color filter 6 is divided into red R, green G and blue B filters at the cell area, which is divided by the black matrix, and transmits each of red, green and blue lights. The common electrode 8 is of a transparent conductive layer which is spread on the entire surface of the color filter 6. The common electrode 8 supplies a common voltage Vcom which becomes the reference voltage when driving the liquid crystal 24. To level the color filter 6, an overcoat layer (not shown) is formed between the color filter 6 and the common electrode 8.

The thin film transistor substrate 20 includes a pixel electrode 22 and a thin film transistor 18, which are formed at each cell area that is defined by the crossing of a gate line 14 and a data line 16, on a lower glass substrate 12. The thin film transistor 18 supplies a data signal from the data line 16 to the pixel electrode 22 in response to a gate signal from the gate line 12. The pixel electrode 22 formed of a transparent conductive layer supplies the data signal from the thin film transistor 18 to drive the liquid crystal 24.

The liquid crystal molecules 24 having dielectric anisotropy rotate in accordance with an electric field, formed by the data signal of the pixel electrode 22 and the common voltage Vcom of the common electrode 8, to control the light transmissivity, thereby realizing the gray level.

The liquid crystal display panel further includes a spacer (not shown) to maintain a cell gap between the color filter substrate 10 and the thin film transistor substrate 20. The spacer can be a ball spacer or a column spacer (not shown). The column spacer is mainly used in a drop-filling liquid crystal forming method and for a large-sized liquid crystal panel. It is typically formed over the overcoat layer that covers the color filter. FIGS. 2A to 2E illustrate a related art method for fabricating a color filter substrate with column spacer.

As shown in FIG. 2A, a black matrix 40 is formed on a substrate 30. The black matrix 40 is formed as a matrix shape by depositing a black matrix material of metal or resin group on the substrate 30 and then patterning it by a mask process.

The black matrix 40 formed on the substrate 30 is then reviewed under a microscope. If a pinhole 40A is found, a black ink is injected by an inkjet method to repair the pinhole 40A of the black matrix 40 as in FIG. 2B.

As shown in FIG. 2C, the R, G, and B color filters are sequentially formed at the corresponding pixel areas on the substrate 30 where the black matrix 40 is formed. The R, G and B color filters are sequentially formed at the corresponding cell areas by repeating a photolithography process in which a corresponding color resist material is formed over the substrate and then exposed and developed.

The R, G, and B color filters are reviewed under a microscope. If a pinhole 42 is found, the corresponding color ink is injected by an ink jet method to repair the pinhole 42 of the color filter as shown in FIG. 2D.

As shown in FIG. 2E, an overcoat layer 44 is formed on the R, G, and B color filters for leveling. The overcoat layer 44 is formed by coating a transparent organic insulating material over the R, Q and B color filters and hardening it. Further, the overcoat layer 44 is patterned by an exposure and development process to be formed only at a picture display area where the R, G, B color filters are formed.

As shown in FIG. 2F, column spacers 46 are formed on the overcoat layer 44. The column spacers 46 are formed by coating a spacer resist over the overcoat layer 44 and patterning it by the exposure and development process.

In the related art color filter fabricating method, the pinhole of the black matrix is repaired by the review/repair process after the black matrix is formed, and then the pinhole of the color filter is repaired by the review/repair process after the R, G, and B color filters are formed. Accordingly, there is a disadvantage in that the production efficiency of the color filter substrate decreases because the review/repair process for removing the pinhole are performed twice.

### SUMMARY OF THE INVENTION

Accordingly, the present invention is directed to a method of fabricating a color filter substrate for a display device that substantially obviates one or more of problems due to limitations and disadvantages of the related art.

An object of the present invention is to provide a pinhole repair method of a color filter substrate that is adaptive for effectively repairing a pinhole which is formed at a black matrix or a color filter.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other objects of the invention, method for fabricating a color filter substrate for use in a display device includes: forming a black matrix on a substrate; forming a color filter layer over the black matrix and the substrate; forming an overcoat layer over the color filter layer; inspecting the black matrix and the color filter layer for pinholes; and if a pinhole is detected in the black matrix or the color filter layer, repairing the detected pinhole by injecting a corresponding ink into the pinhole.

In another aspect of the present invention, a method for fabricating a color filter substrate for use in a display device includes: forming a black matrix on a substrate; forming a color filter layer over the black matrix and the substrate; forming an overcoat layer over the color filter layer; inspecting the color filter layer for pinholes; and if a pinhole is detected in the color filter layer, repairing the detected pinhole by injecting a corresponding ink into the pinhole after forming the overcoat layer.

In yet another aspect of the present invention, method for fabricating a color filter substrate for use in a display device includes: forming a black matrix on a substrate; forming a color filter layer over the black matrix and the substrate; forming an overcoat layer over the color filter layer; inspecting the black matrix for pinholes; and if a pinhole is detected in the black matrix, repairing the detected pinhole by injecting a corresponding ink into the pinhole after forming the overcoat layer.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a perspective view illustrating a related art liquid crystal display panel structure;

FIGS. 2A to 2E are sectional diagrams illustrating a related art method for fabricating a color filter substrate step by step; and

FIGS. 3A to 3C are sectional diagrams illustrating a fabricating method of a color filter substrate step by step according to a first exemplary embodiment of the present invention.

FIGS. 4A and 4B are sectional diagrams illustrating a fabricating method of a color filter substrate step by step according to a second exemplary embodiment of the present invention.

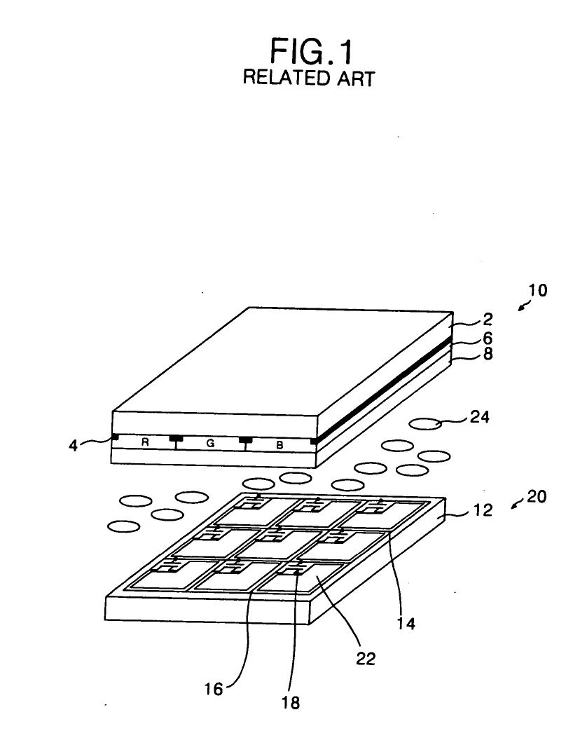

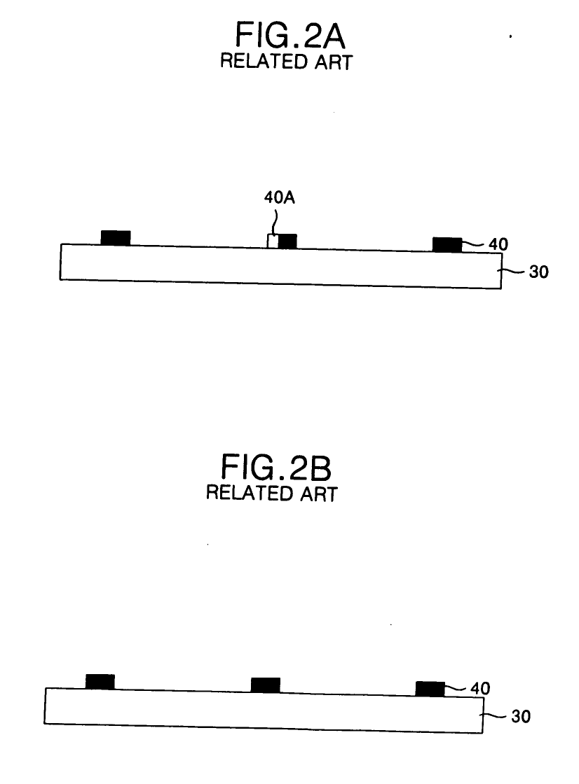

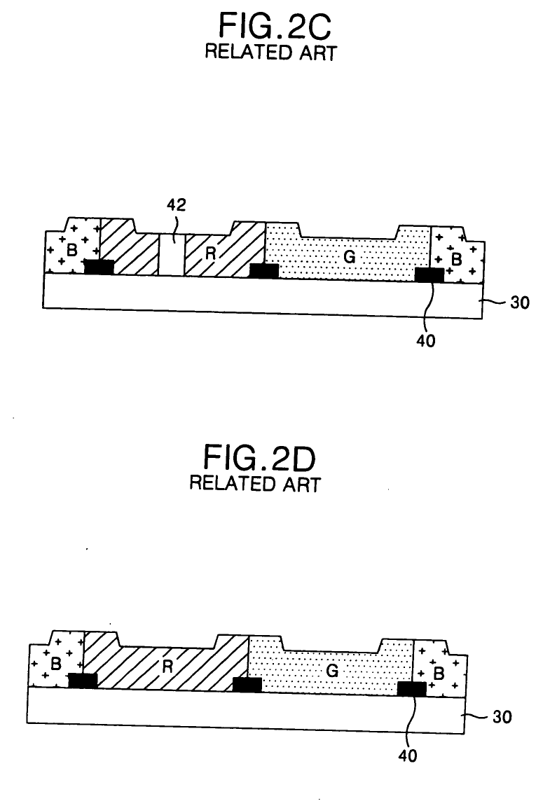

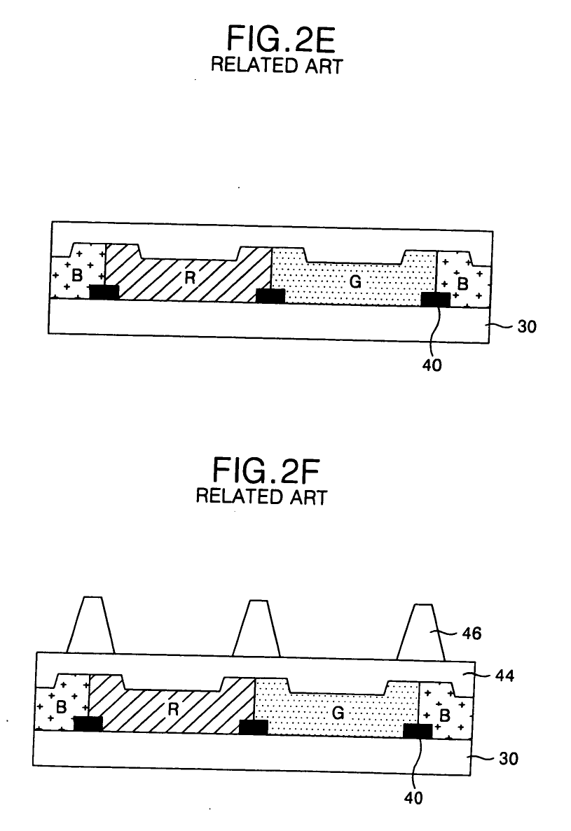

### DETAILED DESCRIPTION OF THE PREFERRED EMBODIMENTS

Reference will now be made in detail to the preferred embodiments of the present invention, examples of which are illustrated in the accompanying drawings.

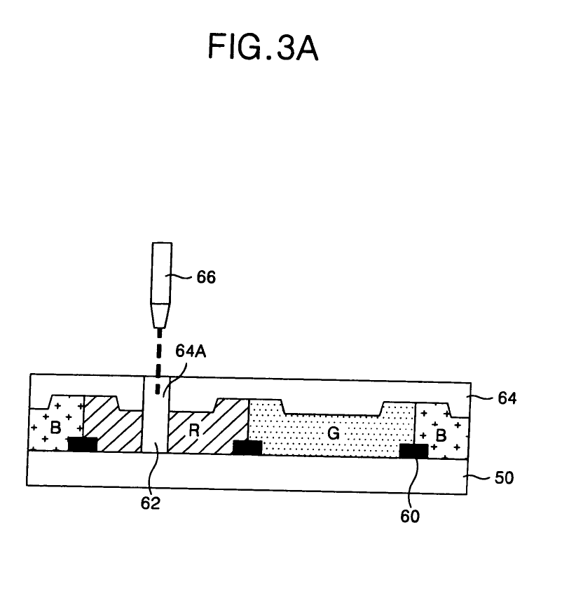

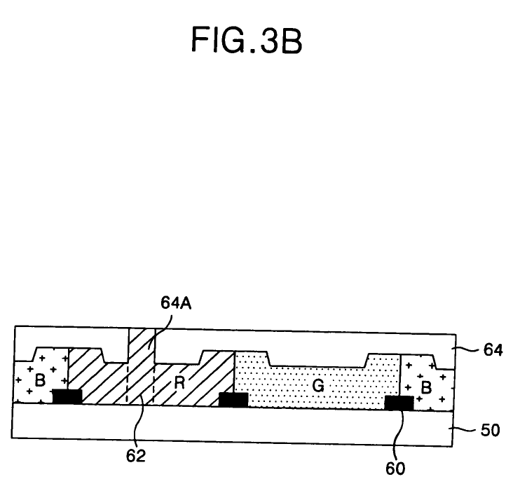

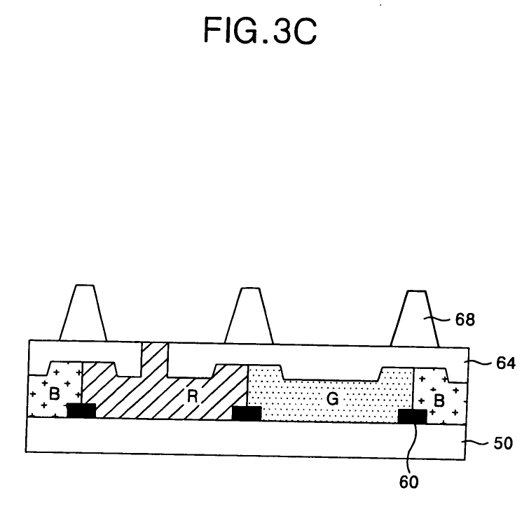

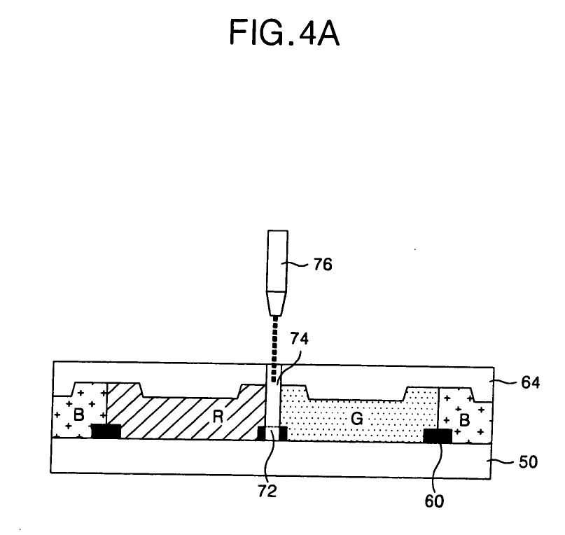

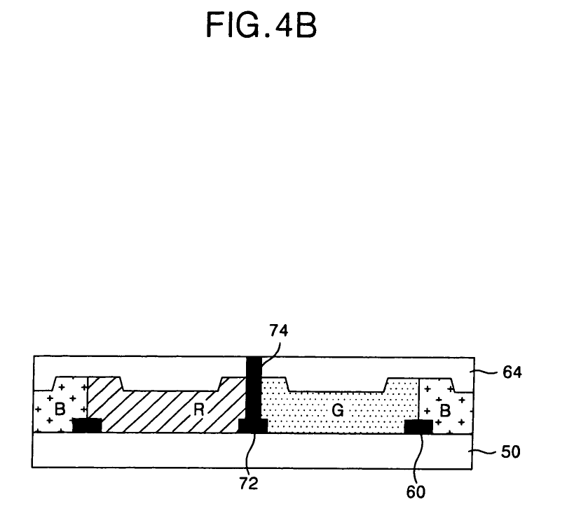

Hereinafter, the preferred embodiments of the present invention will be described in detail with reference to FIGS. 3A to 3C, 4A, and 4B. In the fabricating method according to the first exemplary embodiment of the present invention, as shown in FIG. 3A, a black matrix 60 and R, G, and B color filters are sequentially formed on a substrate 50. An overcoat layer 64 is then formed on the R, G and B color filters.

The black matrix 60 is formed in a matrix shape by patterning a black matrix material of metal or resin group by a mask process after depositing the black matrix material on the entire surface of the substrate 50.

The R, G, and B color filters are sequentially formed at corresponding cell areas by repeating a photolithography process in which a corresponding color resist is formed over the substrate 50 and exposed and developed.

The overcoat layer 64 is then formed by coating a transparent organic insulating material over the R, G, and B color filters and then hardening it. Further, the overcoat layer 64 is patterned by the exposure and development process to cover only a picture display area where the R, G, and B color filters are formed.

The color filter substrate where the overcoat layer 64 is formed is then reviewed under a microscope. If a pinhole 62 exists in the R, G, and B color filters, a laser 66 is irradiated to form an ink injection hole 64A through the overcoat layer 64 in the area substantially corresponding to the pinhole 62 of the color filter. Then, a corresponding ink is injected into the pinhole 62 of the color filter through the ink injection hole 64A of the overcoat layer 64, thereby repairing the pinhole 46A of the color filter as shown in FIG. 3B.

As shown in FIG. 3C, a column spacer 68 is formed on the overcoat layer 64. The column spacer 68 is formed by coating a spacer resist over the overcoat layer 64 and then patterning it by the exposure and development process.

FIGS. 4A and 4B illustrate a second exemplary embodiment of the present invention. After the overcoat layer 64 is formed, the black matrix 60 is reviewed under a microscope. As shown in FIG. 4A, if a pinhole 72 exists in the black matrix 60, a laser 76 is irradiated to form an ink injection hole 74 through the overcoat layer 64 and at least one of the R, Q and B color filters in the area substantially corresponding to the pinhole 72 in the black matrix 60. Then, as shown in FIG. 4B, a black ink is injected into the pinhole 72 in the black matrix 60 through the ink injection hole 74, thereby repairing the pinhole 72. A column spacer is formed on the overcoat layer 64 as described above.

The R, Q and B color filters and black matrix 60 can be examined under a microscope for pinholes in a single review step after the overcoat layer 64 is formed. Then, the repair of the pinhole 62 in the color filters, as shown in FIGS. 3A and 3B, and the repair of the pinhole 72 in the black matrix 60, as shown in FIGS. 4A and 4B, can be performed in the same repair step.

In another exemplary embodiment of the present invention, the foregoing pinhole repair method of the R, G, and B color filters and the black matrix 60 can be applied after the column spacer 68 is formed. In other words, the pinhole repair method for the color filter substrate according to the embodiments of the present invention repairs the pinhole with a single review/repair process after the overcoat layer 64 or the column spacer 68 is formed. Accordingly, the number of review/repair processes can be reduced to one.

As described above, the method of fabricating a color filter substrate according to the present invention repairs pinholes, which are formed in the R, G, and B color filters and/or the black matrix, with a single review/repair process after the overcoat layer or the column spacer is formed. Accordingly, the number of pinhole review/repair process for the color filter substrate can be reduced to one, thereby improving the production efficiency.

It will be apparent to those skilled in the art that various modifications and variations can be made in the method for fabricating a color filter substrate of a liquid crystal panel according to the present invention without departing from the spirit or scope of the invention. Thus, it is intended that the present invention cover the modifications and variations of this invention provided they come within the scope of the appended claims and their equivalents.

1. A method for fabricating a color filter substrate for use in a display device, comprising the steps of:
forming a black matrix on a substrate;
forming a color filter layer over the black matrix and the substrate;
forming an overcoat layer over the color filter layer;
inspecting the black matrix and the color filter layer for pinholes; and
if a pinhole is detected in the black matrix or the color filter layer, repairing the detected pinhole by injecting a corresponding ink into the pinhole.

2. The method according to claim 1, wherein the step of repairing is performed after the step of forming an overcoat layer.

3. The method according to claim 2, wherein the step of repairing includes the steps of:
forming an ink injection hole in the overcoat layer, the ink injection hole being in substantial alignment with the pinhole; and
applying a corresponding ink into the pinhole through the ink injection hole.

4. The method according to claim 1, wherein the step of inspecting includes inspecting for pinholes in the black matrix and in the color filter layer substantially concurrently.

5. The method according to claim 4, wherein the step of repairing includes repairing a pinhole in the black matrix and a pinhole in the color filter layer substantially concurrently.

6. The method according to claim 1, wherein the step of forming the black matrix includes the steps of:
forming a black matrix material over the substrate; and
patterning the black matrix material to form the black matrix.

7. The method according to claim 1, wherein the step of forming the color filter layer includes forming R, G, and B color filters in corresponding areas of the substrate.

8. The method according to claim 1, further comprising the step of forming a column spacer over the overcoat layer.

9. The method according to claim 8, wherein the step of repairing is performed after the step of forming the column spacer.

10. The method according to claim 9, wherein the step of repairing includes the steps of:
forming an ink injection hole in the overcoat layer, the ink injection hole being in substantial alignment with the pinhole; and
applying a corresponding ink into the pinhole through the ink injection hole.

11. A method for fabricating a color filter substrate for use in a display device, comprising the steps of:
forming a black matrix on a substrate;
forming a color filter layer over the black matrix and the substrate;
forming an overcoat layer over the color filter layer;
inspecting the color filter layer for pinholes; and
if a pinhole is detected in the color filter layer, repairing the detected pinhole by injecting a corresponding ink into the pinhole after the step of forming the overcoat layer.

12. The method according to claim 11, wherein the step of repairing includes the steps of:
forming an ink injection hole in the overcoat layer, the ink injection hole being in substantial alignment with the pinhole; and
applying a corresponding ink into the pinhole through the ink injection hole.

13. The method according to claim 11, wherein the step of forming the color filter layer includes forming R, G, and B color filters in corresponding areas of the substrate.

14. The method according to claim 11, further comprising the step of forming a column spacer over the overcoat layer.

15. The method according to claim 14, wherein the step of repairing is performed after the step of forming the column spacer.

16. A method for fabricating a color filter substrate for use in a display device, comprising the steps of:
forming a black matrix on a substrate;
forming a color filter layer over the black matrix and the substrate;
forming an overcoat layer over the color filter layer;
inspecting the black matrix for pinholes; and
if a pinhole is detected in the black matrix, repairing the detected pinhole by injecting a corresponding ink into the pinhole after the step of forming the overcoat layer.

17. The method according to claim 16, wherein the step of repairing includes the steps of:
forming an ink injection hole in the overcoat layer, the ink injection hole being in substantial alignment with the pinhole; and
applying a corresponding ink into the pinhole through the ink injection hole.

18. The method according to claim 16, wherein the step of forming the black matrix includes the steps of:
forming a black matrix material over the substrate; and
patterning the black matrix material to form the black matrix.

19. The method according to claim 16, further comprising the step of forming a column spacer over the overcoat layer.

20. The method according to claim 19, wherein the step of repairing is performed after the step of forming the column spacer.
